(19) United States
(12) Patent Application Publication
(10) Pub. No.: US 2015/0262779 A1
(43) Pub. Date: Sep. 17, 2015

(54) Cathodoluminescent UV Panel

(71) Applicant: Stellarray, Inc., Austin, TX (US)

(72) Inventor: Mark F. Eaton, Austin, TX (US)

(73) Assignee: Stellarray, Inc., Austin, TX (US)

(21) Appl. No.: 14/208,442

(22) Filed: Mar. 13, 2014

(51) Int. Cl. H01J 19/57; H01J 19/32

(52) U.S. Cl. CPC H01J 19/57; H01J 19/32

(57) ABSTRACT

A flat panel UV source emits UV flux from one or more phosphor materials disposed on an anode plate and excited by electron beam current accelerated in vacuum toward the anode from one or more arrays of thermionic filament cathodes. The filament cathode arrays may be constructed and held in one or more cathode frames attached to or near a cathode plate. Increasing the number of these frames allows scaling of the areal size of the source, since the frames are constructed so as to allow for sag of the filaments as they are heated and cooled during operation.

### PRIORITY DATA

Continuation in part of application Ser. No. 12/692,472, filed on Jan. 22, 2010, which is a continuation in part of application Ser. No. 12/201,741, filed on Aug. 29, 2008, which is a continuation in part of application Ser. No. 11/355,692, filed on Feb. 16, 2006, now abandoned, all of which are incorporated herein in their entirety.

Provisional application No. 61/784,326, filed on Mar. 14, 2013.

Provisional application No. 71/478,682, filed on Apr. 25, 2011.

### STATEMENT REGARDING FEDERALLY FUNDED RESEARCH AND DEVELOPMENT

Parts of this invention were made with U.S. Government support under Contract No. FA9451-04-M-0075 awarded by the U.S. Air Force and National Science Foundation Grant No. 1013887. The Government has certain rights in the invention.

### BACKGROUND OF THE INVENTION

This invention provides a flat panel source of radiation which uses cathode arrays to emit electron beam current over a wide area to excite cathodoluminescent phosphors emitting in the ultraviolet (UV) portion of the electromagnetic spectrum (100 to 400 nanometers in wavelength). The phosphors can be selected to emit in any part or parts of the UV bands. UV-A and UV-B phosphors can be used for applications such as curing adhesives, powder coatings, medical phototherapy, blood pathogen inactivation, joining of composite materials, or epoxy curing. UV-C phosphors can be incorporated in the panel source of this invention for applications such as water or air purification, through either direct or photocatalytic sterilization of contaminants. UV phosphors emitting in lower wavelength UV bands can be used in panels for photolithography and other applications. In certain aspects of this invention, the ultraviolet phosphors can be mixed together to provide a desired multi-spectral output. In other aspects, different wavelength phosphors can be deposited on different parts of the phosphor plate, so that the different spectra can be selectively addressed for light emission.

Most UV sources now used are fluorescent gas discharge tubes or lamps, most commonly with a low or medium pressure mercury vapor medium for the gas discharge. These sources have a number of limitations, including the hazard of the mercury in the tubes, risks of breakage, narrow spectral range, low power efficiency, especially in the case of medium pressure mercury vapor tubes, sensitivity to temperature variations, heat generation, and difficulties in cleaning and maintenance in some applications. UV light emitting diodes (LEDs) have been developed more recently. These have low power efficiency below about 365 nm in wavelength and also suffer from “droop”, a phenomenon in which power efficiency drops further as power output is increased. LEDs are made on compound semiconductor wafers such as AlGaN, so they are expensive to begin with and then have to be diced and assembled for larger area applications, which adds further to the cost of a wide area UV source.

U.S. Pat. Nos. 4,274,028 and 7,300,634 disclose flat panel sources of cathodoluminescent UV flux in which the phosphors are excited by electron beam current emitted from cold cathode films or cold cathode arrays. Cold cathodes are expensive to make and in practice have had limited lifetimes and stability, particularly in high voltage environments. Cold cathode arrays also block UV radiation and have to fill much of an area to provide broad distribution of electrons over a corresponding anode surface. Vacuum fluorescent displays (VFDs) have also been made for some time, mainly for segmented character displays. These have been limited to the visible light bands, do not have separate cathode frames inside the vacuum package so as to enable scaling to large sizes, and use phosphors which are excited at low electron beam energies, as these are meant to be low power, portable displays. A number of UV phosphors have also been developed for various purposes. UV-C phosphors were originally developed not for sterilization applications but for testing cathode ray tubes.

### OBJECTS AND ADVANTAGES OF THE INVENTION

It is an object of this invention to provide an inexpensive, power-efficient source of UV flux in a convenient flat panel format which can easily be scaled both in terms of physical size and power output. The ability to make these panels inexpensively in large sizes means they can be used in applications such as the sterilization of air and other gas flows, or water and other fluid flows. An important advantage of this invention is its ability to dissipate the heat created during impact of the UV phosphors by electron beams during operation, thereby mitigating the coulombic aging of the phosphors and prolonging the lifetime of the panel. Other objects of the invention are to provide variation of the ultraviolet emission bands both between different panels and in other cases within the same panel by the use of different phosphor materials. Further objects of the invention are to provide a flat panel UV source which emits from both sides of the panel and to provide a UV source in which the light is collimated. Yet another object of the invention is to provide a flat panel UV source in which powder laser phosphors are used instead of cathodoluminescent phosphors to further increase the power efficiency of the source.

### SUMMARY OF THE INVENTION

The invention disclosed herein provides a flat panel UV source in which the UV flux is emitted by one or more phosphor materials disposed on an anode plate made of and excited by electron beam current accelerated in vacuum toward the anode from one or more arrays of thermionic filament cathodes. The filament cathode arrays may be constructed and held in one or more cathode frames attached to or near a cathode plate. Increasing the number of these frames allows scaling of the areal size of the source, since the frames are constructed so as to allow for sag of the filaments as they are heated and cooled during operation. A grid electrode may be used to more uniformly spread the current from cathode arrays. The anode plate and cathode plate are parallel to each other and form the major members of the vacuum enclosure of the source. In reflective mode panels, the cathode array and grid are made with substantial open area, and the cathode plate is made of UV transparent material, so as to allow UV light reflected from the anode plate to pass through the cathode plate. In transmissive mode panels, the anode plate is made of UV transmissive material to that UV light is emitted away from the cathode side. In transmissive mode panels, a layer of material with a high coefficient of secondary electron emission may also be used in conjunction with the cathodes, so that electron emission is first from the cathode arrays to this layer, and then from this layer, with the current amplified, to the anode.

### BRIEF DESCRIPTION OF DRAWINGS

FIG. 1 shows the UV source of this invention in which one or more arrays of thermionic filament cathodes attached to or near a cathode plate are heated to emit electrons which are accelerated under a high voltage towards an anode plate. The interior, vacuum-facing surface of anode plate is covered with UV phosphors which emit UV flux upon impact by the electron beam current. A mesh grid can be used to gate the flow of electronics toward the anode and to spread the electron beams so that they cover the anode more uniformly. FIG. 1 shows the panel in reflective mode, with the UV light passing through cathode and optional grid structures with substantial open area and exiting the panel on the cathode side.

FIG. 2 shows a double-side construction of the reflective mode source of this invention.

FIG. 3 shows the transmissive mode source of this invention, with the UV light being emitted through the anode plate and away from the cathode plate.

FIG. 4 shows a double-sided construction of the transmissive mode source of this invention.

FIG. 5 shows an embodiment of this UV source in which the filament cathodes, when heated, emit electrons which are directed to a layer disposed on the cathode plate and comprised of a material with a high secondary electron emission coefficient by a first voltage. A conductive layer under the secondary electron emission layer supplies additional current, which upon emission from the secondary electron emission layer is accelerated towards the phosphor covered anode plate to emit UV flux.

FIG. 6 shows a top view of a filament cathode array frame used in the flat panel UV source of the invention.

FIG. 7 shows an oblique view of a filament cathode array frame used in the flat panel UV source of the invention.

FIG. 8 shows a grid mesh electron which can be used in the flat panel UV source of this invention.

FIG. 9 shows an anode plate in which the phosphors have been disposed in individually addressable sections.

### DETAILED DESCRIPTION OF THE INVENTION

Although the following detailed description delineates specific attributes of the invention and describes specific designs and fabrication procedures, those skilled in the arts of electronics or radiation source production will realize that many variations and alterations in the fabrication details and the basic structures are possible without departing from the generality of the processes and structures. The most general attributes of the invention relate to the generation of UV flux from phosphors coated on wide, transmissive anode plate and excited by electron beam current(s) from one or more thermionic cathode filament arrays mounted in frames on or near a cathode plate opposite the anode plate and separated by vacuum.

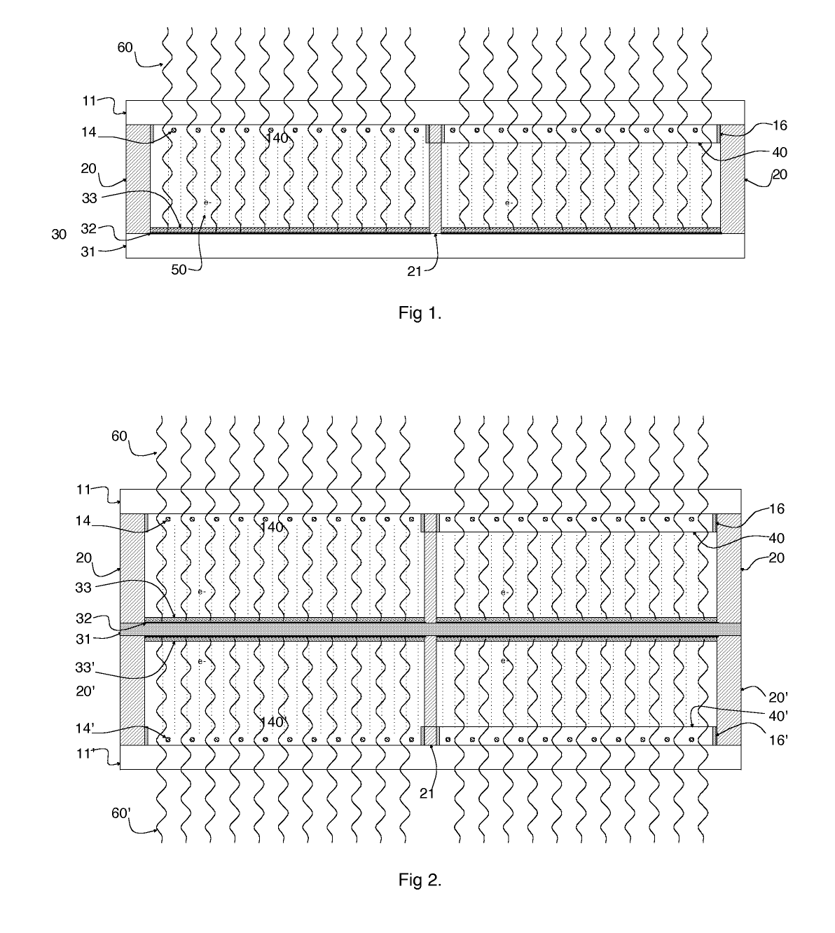

The basic construction of the flat panel UV source of the present invention is shown in FIG. 1. A cathode plate 11, anode plate 31 and side walls 20 are hermetically sealed to form the internal vacuum environment needed for operation of this cathodoluminescent source. Support pillars or walls 21 may be provided to mechanically support the cathode and anode plates under atmospheric load and allow the source to be made in wide formats. Thermal filament arrays 140, comprised of spaced apart metal wires 14, held in place by filament frame 16, are mounted on or near the cathode plate and heated, such as by resistive heating, to emit a cloud of electrons. The electron beam current 50 may be directly accelerated towards the anode plate by an acceleration voltage between the anode plate and the filaments, or between the anode and a metallic ground plane (thin film of UV transparent conductive material) formed on the cathode plate. Alternatively, a mesh grid 40 with substantial open area (preferably over 90% open) can be operated to gate the flow of electrons toward the anode. This grid electrode also has the function of more evenly distributing the electron beam current across the anode plate.

UV phosphor layer 33 is deposited on anode plate 31 and emits UV flux 60 when struck by accelerating electron beam current 50. The phosphor layer itself may provide the electrical connection for the anode bias. A thin-film conductive layer 32 may also be disposed between the phosphor layer and the anode plate to provide this electrical connection. This conductive layer may be formed by sputtering, thermal evaporation, electroplating or other methods known in the art of thin film deposition. Conductive layer 32 may be made of a UV reflective metal, such as aluminum, or anode plate 31 may be made of such UV reflective metal, and cathode plate 11 made of UV transmissive material, such as quartz, to provide the reflective mode source of this invention, in which the UV light is reflected from anode 30 back through filament array 140 and optional grid 40 and out cathode plate 11. By making anode plate 31 out of a metal or other material with high thermal conductivity, heat created by electron impact on the phosphors is more efficiently removed from the phosphor layer, reducing coulombic aging and prolonging the life of the panel.

Alternatively, anode plate 31 may be made of a UV transparent material such as quartz and metal layer 32 either eliminated or made of a UV transparent material or made very thin so as to allow the transmission of UV light. In this embodiment, the source will emit UV light out of both sides of the panel.

FIG. 2 shows an alternative embodiment of a source which emits out of both sides of the panel. In this embodiment, two of the sources of FIG. 1 are made back to back, sharing a common anode plate 31. In addition to having potentially twice the source power, anode plate 31 may be made of a metal with high thermal conductivity, which further may be provided with cooling channels, so as to remove heat form the phosphor area and allow the source to be operated at high power levels over prolonged periods.

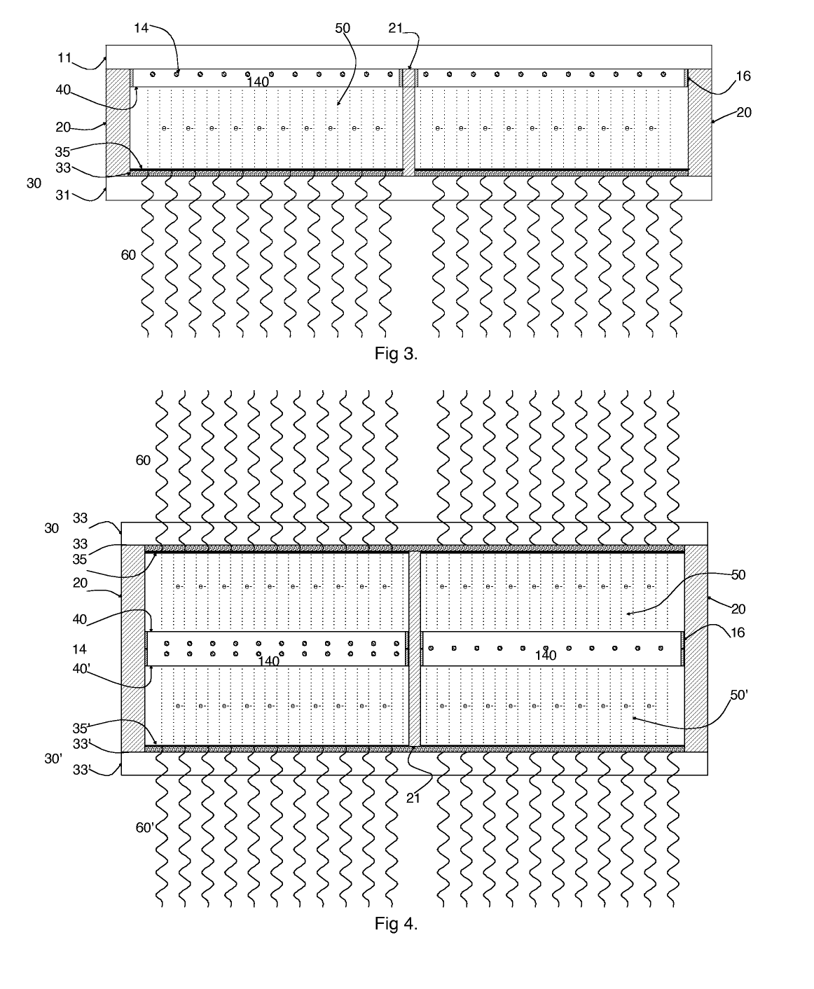

A transmissive source embodiment of the UV source is shown in FIG. 3, in which embodiment anode plate 31 is made of UV transmissive material, such as quartz or a borosilicate glass with high UV transmission so as to allow UV flux 60 to exit that side of the panel, away from the cathode plate. For UV phosphors which emit light upon impact of higher energy electrons, generally above 3 kV, a thin reflective metal layer 35, for example of aluminum, may be deposited over phosphor layer 33 with the opposite surface of the metal layer facing the vacuum of the source. Higher energy electrons will penetrate this metal layer and excite the phosphors. The metal layer will suppress outgassing from the phosphors into the vacuum and reflect UV light emitted in the direction of the vacuum and cathode array back out the anode plate, so as to increase the power efficiency of the source.

FIG. 4 shows a double-sided transmissive embodiment of the source. In this embodiment there are two anodes 30 on opposite sides of the source. Filament cathode array 140 is disposed between the two anodes and the source has one vacuum envelope. Filament array 140 may be made in two sets, one for each side of the source, or both anodes may share a common filament array. Electrons given off by heated filament array 140 are directed towards the upper and lower anodes by upper and lower gate grids 40.

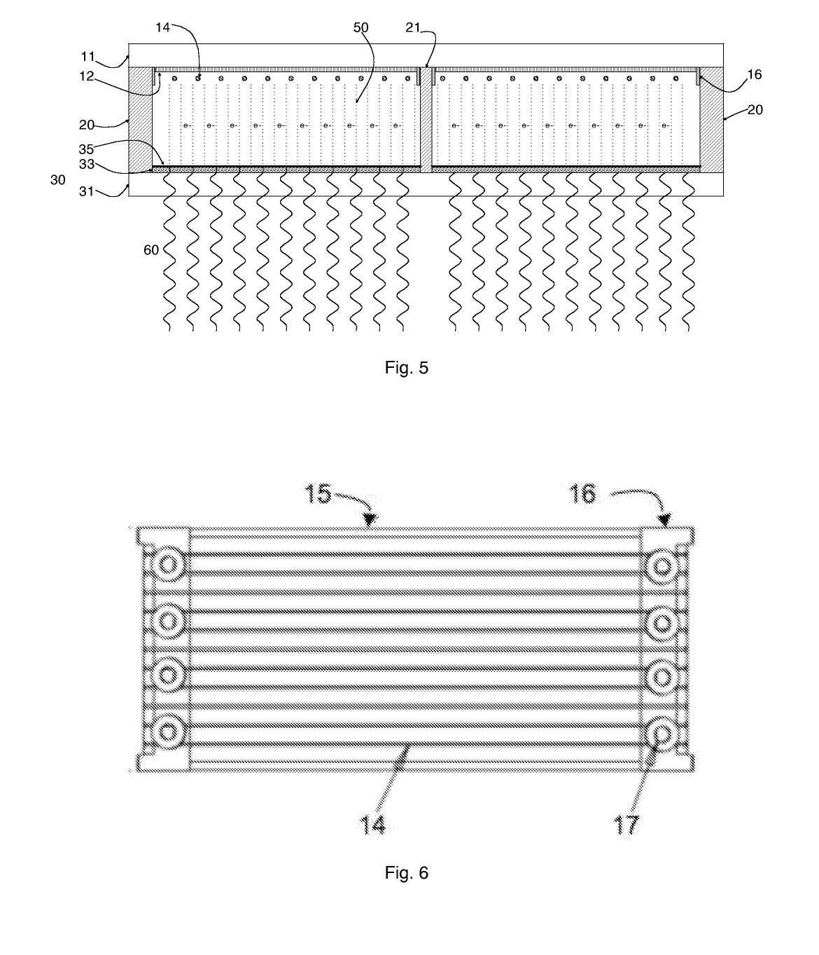

In an transmissive embodiment of the source, shown in FIG. 5, a layer of material with a high secondary electron emission coefficient 12, such as MgO, is deposited on cathode plate 11. A conductive layer under the secondary emission layer is provided to supply additional current. Electrons from the cathode array(s) 140 induce an amplified level of secondary emission, this beam current then being accelerated toward anode 30 to emit UV flux.

In the transmissive embodiments of the source, the thickness of anode plate 31 is chosen to allow as much of the UV flux out of the source as possible while at the same time providing sufficient mechanical strength to withstand atmospheric load. An exemplary thickness of a quartz sheet used as the anode plate is between 1 mm and 5 mm. Cathode plate 11 should be of similar composition and thickness if UV flux is desired to emit out the cathode plate as well, for a double-sided source. Otherwise, in a one-sided transmissive source, cathode plate 11 can be of any thickness needed for mechanical strength under atmospheric load. The cathode plate may also be made of metals or other materials with high thermal conductivity so as to allow cooling of the source from the outer surface of the cathode plate. External cooling structures such as heat sinking materials, air cooling fins or fluid cooling structures may be added to the external side of the cathode plate to allow the source to operate at high power levels.

In all embodiments of the source, the side walls 20 form the other parts of the vacuum envelope of the source. These are preferably made of an insulating material such as glass or ceramic and may be made of the same material, such as quartz or borosilicate glass, as the anode plate. Internal support bars, walls or spacers 21 may be added between the cathode and anode plates to provide separation between the two plates and mechanical strength under vacuum load for wide panels. The support structures and walls are preferably coated with a charge bleed layer made of a very thin film of metal or semiconductor material so as to drain any charge built up from stray electrons or ions produced in operation and prevent electrical flashover inside the vacuum package. These structural components—anode plate, cathode plate, side walls and internal support bars—are chosen to have similar coefficients of thermal expansion so as to reduce thermal stresses in the vacuum envelope as the source is being operated.

The accelerating voltage in the source of the present invention is provided by an external power supply connected to the ground plane, filaments or grid on one side and the phosphor layer, transparent conductive layer or metal covering layer on the anode side through electrical connections running through the vacuum package of the source. The accelerating voltage is chosen to fit the electron energy level needed for efficient excitation of the phosphors. With some exemplary UV-C phosphors this is between 5 kV and 20 kV. For other phosphors much lower voltages, for example under 1 kV, are most sufficient. The source may be operated in DC mode, with a constant stream of electron beam current supplied to the anode, or it may be pulsed so as to prolong phosphor life or increase the intensity of the UV flux.

The power level of the source is chosen based on the efficiency of the phosphor and flux intensity needed for the application. In an exemplary application of UV-C panels such as sterilization of air or water, the desired flux is about 15 mW/cm². Some available UV-C phosphors operate at peak conversion efficiency of about 10% at a voltage of about 8 kV. In this case, about 0.02 mA/cm² is required from the cathode arrays, to deliver about 6 W of UV-C flux from the panel with 60 W of input power. The size of the panel may be made as wide as needed to accommodate the thermal load generated by this power level, and panels may be tiled side by side if needed.

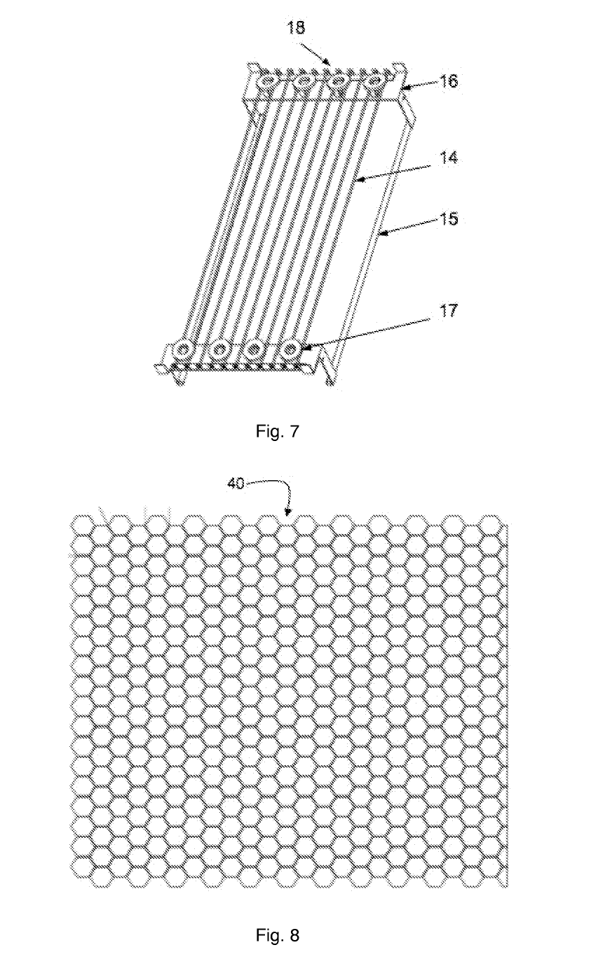

Numerous types of cathode arrays can be used to supply the electron beam current in the disclosed flat panel UV source, including thermal filament arrays, thin film thermal filament cathodes, photocathodes and cold cathode arrays. A preferred cathode array, shown in FIGS. 6 and 7, is an array of thermal cathode filaments 14 held in a frame. FIG. 6 shows a multiplicity of filaments in parallel stretched between two frame ends 16, which are preferably made of metal but can also be made of an insulating material provided that conductive leads are disposed in the frame ends to connect to the filaments. As shown in FIG. 6, frame sides 15 are provided to keep the frame rigid during manufacturing and assembly. These may be left in place if made of an insulating material. Alternatively, they be made of metal and snapped off or otherwise detached once the filament frame is securely attached to the cathode plate or other support structures by fritting, welding mechanical attachment or other attachment means. In this method, shown more clearly in FIG. 7, the filament frames may be made very inexpensively as one piece out of stamped metal sheet. As shown in FIG. 7, leaf, coil or other springs 18 are provided on at least one of the frame ends to keep the filaments taut and prevent sagging as the filaments expand and contract under heating. FIGS. 6 and 7 also show that simple ring getters 17 may be conveniently placed on the filament frame. These are activated after vacuum sealing of the source to absorb gases released inside the source during operation, thereby maintaining vacuum, which can be from 10⁻⁵ to 10⁻⁸ Torr. Non-evaporable getters may also be affixed inside the source or in a separate vacuum compartment in communication with the vacuum envelope of the source to maintain vacuum.

Filament sagging is to be avoided since too much of the current will be provided from the middle of the filament, which will make the UV flux uneven and shorten cathode lifetime. When a grid is used, the filament can short to the grid if it sags too much. An exemplary length of the filaments in the disclosed source is from 10 mm to 200 mm. The diameter can be of any width desired, but will generally be under 200 microns. By holding the filaments in frames, the areal size of the source can be scaled to as large as desired simply by adding more frames. The frames are mechanically attached to the cathode plate, side walls or support bars by clips, welding, frit adhesion, connecting rods or any other suitable mechanical means. The filaments may be made of any thermionic emitting material. Exemplary materials include W wires, thoriated (2.5%) W (Th—W) wires, low temperature Barium-coated W (Ba-coated W), and Triple Carbonate (Ba—Sr—Ca)CO₃ coated W wires. It will be noted from FIGS. 6 and 7 that there is substantial open area between the filaments. In an exemplary configuration, the frame will be 50 mm wide and each of ten filaments only 50 microns in diameter, so only 1% of the space between the frame ends will be blocked to UV light coming from the phosphors. The frame ends are then made in as small a form factor as possible to minimize the space blocked by them.

Any cathodoluminescent or powder laser phosphor, including nanoparticle phosphors, can be used in the disclosed source, which can therefore emit light in a number of spectral regions. A number of phosphors exist in the prior art which emit UV-C in response to cathodoluminescent excitation. U.S. Pat. No. 3,941,715 discloses a zirconium pyrophosphate phosphor, while U.S. Pat. No. 4,014,813 discloses a hafnium pyrophosphate phosphor and U.S. Pat. No. 4,024,069 discloses a yttrium tantalate phosphor, all of which emit UV-C radiation in response to excitation by an electron beam. In addition, lanthanum pyrophosphates are also known to emit UV-C in response to cathodoluminescent excitation. More recently, powder laser phosphors have been developed which emit in the UV-C region (Williams et al, “Laser action in strongly scattering rare-earth-metal-doped dielectric nanophosphors,” Phys. Rev. A65, 013807(2001); and Li, et al, “Continuous-wave ultraviolet laser action in strongly scattering Nd-doped alumina,” Opt. Lett. 27, 394(2002)). Other phosphors can be used for UV-A and UV-B emission. These include phosphors, typically based upon borate, fluoroborate and silicate compounds, for UV-A lamp applications such as tanning beds, black lights and medical procedures. These are generally now excited by gas discharge but may also perform under accelerated electron impact. Other phosphors may be chosen for high cathodoluminescent efficiency, such as sulfur-containing phosphors. These include ZnS based phosphors developed for CRT applications, and Pb activated CaS. Other S containing phosphors, such as the Ca/Ba sulfates activated with Eu or Ce may also be used. For example, CaSO₄:Eu has a relatively narrow emission peaking at 388 nm while CaSO₄:Ce has a broad emission peak extending from 300 to 345 nm.

Powder phosphors may be deposited on the anode plate by settling with or without phosphor particle binders, by electrophoretic methods, screen printing, pressing, or by ink jet methods. In the case of powder laser phosphors, with the electron beam current is pulsed to pump the laser materials. Thin-film phosphors may also be used, in which case subsequent doping of the layer may be used to tune the spectral distribution of the flux. Scintillating ceramic phosphor layers are another exemplary material for the phosphor layer.

A current gating grid may be provided between the cathode array and anode, but closer to the cathode array to modulate the electron beam current and to provide more even distribution of the beam current over the anode plate. The grid is preferably made from a thin metal foil 40 etched to provide substantial open area, as shown in FIG. 8. A suitable grid voltage will extract electrons from the cloud emitted by the cathodes and direct them towards the anode. As a rule of thumb, the grid voltage is generally most effective at about 100 V per mm of separation between the grid and the cathodes. The grid may be formed as a continuous foil covering all or part of the area of the source, or it may be formed in sections corresponding to the area of the cathode frame. It can be secured beneath the cathodes by a number of methods, including mechanical attachment to the source walls or support bars, or directly to the under side of the cathode frames.

The disclosed source may be evacuated and sealed by a number of methods known in the art. The distance between the cathode plate and the anode plate may be set according to the electrical potential used between cathode and anode. The distance should be sufficiently large to prevent arcing or other vacuum breakdown between cathode at anode at the chosen voltage. It should also be large enough to prevent external breakdown between conductive components such as feedthroughs on the external side of the source. An exemplary distance for a 10 keV potential between the cathode and anode is 2-10 millimeters. The cathode plate, anode plate and side walls may be joined with frit glass sealing techniques common in the vacuum tube and flat panel display industries. Quartz plates and walls may be sealed through frit seals in some cases, or they may be flame sealed. Another method for sealing is to provide a compressible solder outside of the side walls, in place of the side walls or between the side walls and the cathode and anode plates. The source is then pressed together so as to press the solder into place as a hermetic or near hermetic seal. Epoxy may be applied outside this solder seal, or mechanical clips may be applied, to hold the assembly together. Alternative sealing methods include O-ring seals of high-temperature materials such as Viton™ and mechanical clamping supports, vacuum-compatible epoxies or silica-based sealants. Electrical connection and getter activation feedthroughs may be provided through side walls, cathode plate and anode plate. Vacuum evacuation of the source may be accomplished through vacuum pumping through a pinch-off tube or valve attached to the source, or the assembly may be sealed in vacuum. The assembly is preferably heated during assembly to drive off residual gasses before being sealed to external atmosphere. This heating may be provided by a conventional or vacuum oven, or by the use of hot plates outside of the cathode and anode plates.

The support structures which maintain the vertical spacing between the cathode and anode plates and provide mechanical support under atmospheric load may be made of glass, quartz, ceramic or other insulating materials, coated with a charge bleed layer. They are spaced depending on the thickness of the thinnest of the cathode or anode plates. With a 2 mm thickness of borosilicate glass or quartz, for example, support structures should be provided at least every 50 mm. These support structures may be made in any suitable shape, for example rods, bars, walls, crosses or square pillars. They may be attached to the anode or cathode plates with frit material, or they may be attached to or through the cathode frames. One method for holding the support members in place is to make separate frames for the cathodes and grid, and provide holes in the frames that can accept the support members. Internal walls may also be formed of glass or ceramic to provide such spacer support. These internal walls may be arranged as a grid so as to allow the attachment of smaller anode plates in each grid opening, thereby creating a tiled anode structure.

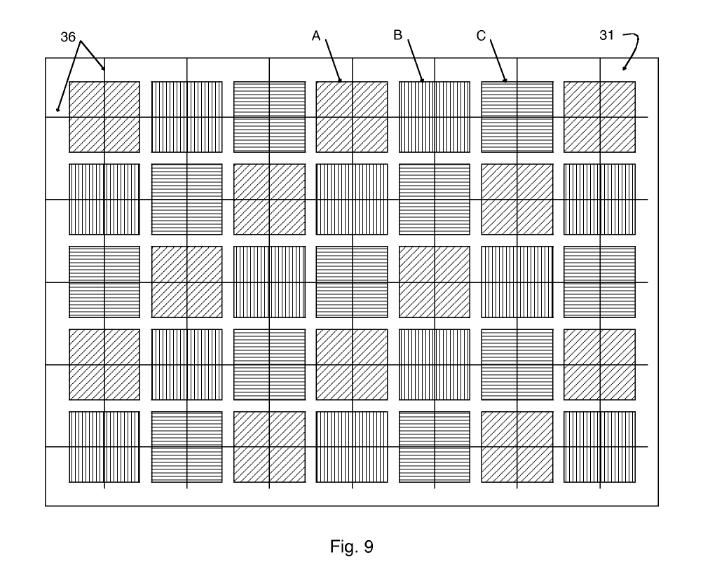

The phosphors on anode plate 31 may also be formed in discrete, electrically addressable sections, as shown in FIG. 9, so that different phosphors may be selectively addressed for emission in different UV spectral bands. Address lines, such as the matrix address lines 36 shown in FIG. 6, may be be formed above or below the phosphor regions and used to provide the anode potential only at the addressed section.

In applications, such as lithography, requiring a collimated source of UV flux, collimating or focusing grids of UV absorptive or reflective material may be placed outside the anode plate.

The present invention is well adapted to carry out the objects and attain the ends and advantages described as well as others inherent therein. While the present embodiments of the invention have been given for the purpose of disclosure numerous changes or alterations in the details of construction and steps of the method will be apparent to those skilled in the art and which are encompassed within the spirit and scope of the invention.

What is claimed is:

1. A flat panel source of UV flux comprising:
at least one metal wire filament cathode array formed on or near a cathode plate, operable to emit an electron beam current towards an anode plate covered with cathodoluminescent UV phosphors;
said cathode plate, side anode plate and side walls forming the vacuum enclosure of the source; and
at least one of the cathode plate or anode plate being substantially transparent to the UV light of the source;
said electron beam current thereby causing said cathodoluminescent UV phosphors to emit UV light out of the source.

2. The source of claim 1 in which:
the filaments in said filament array(s) are spaced apart so as to provide a distance between filaments at least ten times as great as the diameter of the largest filament;
the phosphors are deposited on to a UV reflective surface of an anode plate having at least one such UV reflective surface; and
the cathode plate is substantially transparent to the UV light of the source;
the source thereby operable to emit UV light back towards the cathode plate, through the spaces between the filaments in the filament array(s) and out the cathode plate.

3. The source of claim 1 in which the anode plate is substantially transparent to the UV light of the source, thereby allowing UV light to emit out the anode plate.

4. The source of claim 3 in which a thin layer of UV reflective metal is deposited over the phosphor layer side distal to the anode plate.

5. The source of claim 3 in which a layer of material with a secondary electron coefficient greater than 1 is deposited on the cathode plate, thereby to receive and amplify current from filament cathode arrays proximate the cathode plate, and further to emit such amplified current towards the anode plate.

6. A source of claim 1 in which two of the sources of claim 2 are made back to back, and share an anode plate, thereby operable to emit UV light from both sides of the panel.

7. A flat panel source of UV flux comprising:
at least one planar array of wire metal wire filament cathodes operable to emit electron beam currents to both sides of said planar array;
two anode plates, each substantially transparent to the UV light of the source and covered with cathodoluminescent UV phosphors;
the two anode plates and side walls forming the vacuum enclosure of the source;
said electron beam currents thereby causing said cathodoluminescent UV phosphors to emit UV light out of the source.

8. The sources of claims 1 and 7 in which UV-C phosphors belong to the group consisting of zirconium pyrophosphate; hafnium pyrophosphate, yttrium tantalate and lanthanum pyrophosphate.

8. The sources of claims 1 and 7 in which UV-C phosphors are operable as powder laser phosphors in response to pulsing of the electron beam current.

9. The sources of claims 1 and 7 in which an electron current gating grid is provided proximate the filament cathode array(s) wherein said gating grid has substantially the same area as the filament cathode array(s) and is at least 75% open space.

10. The sources of claims 1 and 7 in which the vacuum seal of the source is formed by a compressible solder between at least one anode plate and the side walls, with an outer seal of epoxy or mechanical retaining means to hold the seal in place.
